(19) United States
(12) Patent Application Publication
(10) Pub. No.: US 2017/0227924 A1
(43) Pub. Date: Aug. 10, 2017

(54) IMAGE FORMING APPARATUS

(71) Applicant: FUJI XEROX CO., LTD., Tokyo (JP)

(72) Inventors: Misa HISHIDA, Yokohama-shi (JP); Ryuichi SATO, Ebina-shi (JP)

(73) Assignee: FUJI XEROX CO., LTD., Tokyo (JP)

(21) Appl. No.: 15/235,850

(22) Filed: Aug. 12, 2016

(30) Foreign Application Priority Data
Feb. 8, 2016 (JP) 2016-022019

(51) Int. Cl. G03G 21/16; G03G 15/00

(52) U.S. Cl. CPC G03G 21/1695; G03G 15/6529

(57) ABSTRACT

An image forming apparatus includes a moving member that is movable between a first position and a second position different from the first position, first stop member that is disposed corresponding to the first position and comes into contact with the moving member to stop the moving member in the first position, a second stop member that is disposed corresponding to the second position and comes into contact with the moving member to stop the moving member in the second position, a first shock absorber dial is disposed in at least one of the moving member and the first stop member, and absorbs impact at a time of contact, and a second shock absorber that is disposed in at least one of the moving member and the second stop member, and absorbs impact at a time of contact.

### CROSS-REFERENCE TO RELATED APPLICATIONS

This application is based on and claims priority under 35 USC 119 from Japanese Patent Application No. 2016-022019 filed on Feb. 8, 2016.

### TECHNICAL FIELD

Exemplary embodiments of the invention relate to an image forming apparatus.

### SUMMARY

According to an aspect of the invention, an image forming apparatus includes:

a moving member that is movable between a first position and a second position different from the first position;

a first stop member that is disposed corresponding to the first position and comes into contact with the moving member to stop the moving member in the first position;

a secondstop member that is disposed corresponding to the second position and comes into contact with the moving member to stop the moving member in the second position;

a first shock absorber that is disposed in at least one of the moving member and the first stop member, and absorbs impact at a time of contact; and

a second shock absorber that is disposed in at least one of the moving member and the second stop member, and absorbs impact at a time of contact.

### BRIEF DESCRIPTION OF THE DRAWINGS

Exemplary embodiments of the present invention will be described in detail based on the following figures, wherein:

FIG. 1 is an entire explanatory view of an image forming apparatus of Example 1 of the invention;

FIG. 2 is an explanatory view of a visible image forming member having an image holding member unit and a developing device of Example 1 of the invention;

FIG. 3 is an explanatory view of a post-processing device of Example 1 of the invention;

FIG. 4 is an explanatory view illustrating a side stitching device of Example 1 of the invention and is an explanatory view illustrating movement of a clamp roller;

FIG. 5 is an explanatory view illustrating the side stitching device of Example 1 of the invention and is an explanatory view illustrating movement of a sub-paddle; and

FIG. 6 is an explanatory view of an opening and closing mechanism of an exterior member in the post-processing device of Example 1 of the invention.

### DETAILED DESCRIPTION

Next, specific examples (hereinafter, referred to as an example) of exemplary embodiments of the invention will be described with reference to the drawings, but the invention is not limited to the following examples.

Moreover, in order to facilitate understanding of tine following description, in the drawings, a forward and rearward direction is an X-axis direction, a rightward and leftward direction is a Y-axis direction, an upward and downward direction is a Z-axis direction, directions or sides indicated by arrow X, −X, Y, −Y, Z, and −Z are respectively a front side, a rear side, a right side, a left side, an upper side, and a lower side, or forward, rearward, rightwards leftward, upward, and downward.

In addition, in the drawings, a mark in which “” is drawn in “O” means an arrow directed from the rear side to the front side of a paper surface, and a mark in which “x” is drawn in “O” means an arrow directed from the front side to the rear side of the paper surface.

Moreover, to the following description using the drawings, in order to facilitate understanding, illustration other than members necessary for the description is appropriately omitted.

### EXAMPLE 1

### Description of Entire Configuration of Printer U of Example 1

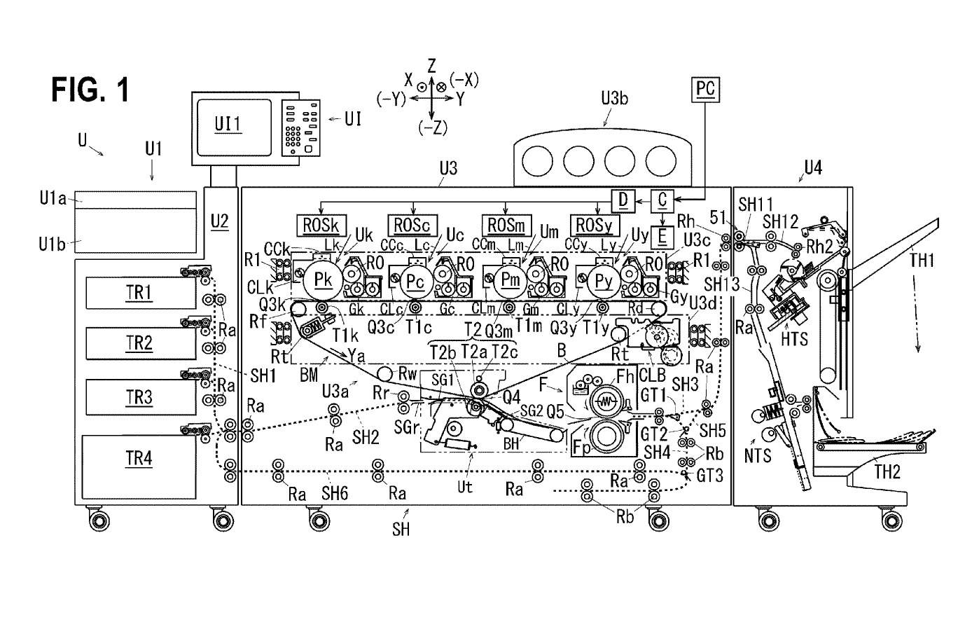

FIG. 1 is an entire explanatory view of an image forming apparatus of Example 1 of the invention.

In FIG. 1, a printer U of an example of the image forming apparatus of Example 1 has a scanner portion U1 as an example of a reading device of image information. A sheet feeding device U2 as an example of a supply device of a medium is disposed below the scanner portion U1. A printer body U3 as an example of a body of the image forming apparatus is disposed on a right side of the sheet feeding device U2. A finisher U4 as an example of a post-processing device is disposed on a right side of the printer body U3. In addition, a user interface U1 as an example of an operation portion is supported on an upper side of the sheet feeding device U2.

The user interface UI has a display panel UI1 as an example of a display portion, input buttons such as a copy start key, a ten key, an input key to input the number of copies, and the like.

The scanner portion U1 includes a document feeder U1a as an example of a transporting device of a document, an image scanner U1b as an example of a reading portion of the image, and the like.

The sheet feeding device U2 has plural sheet feeding tray trays TR1 to TR4 as an example of a accommodating container of the medium. Sheets S as an example of the medium are housed in each of the sheet feeding fray trays TR1 to TR4. A supply path SH1 as an example of a transporting path is loaned within the sheet feeding device U2. The supply path SH1 connects the sheet feeding tray trays TR1 to TR4 to the primer body U3.

### Description of Configuration of Image Recording Portion U3a of Example 1

In FIG. 1, the printer body U3 has an image recording portion U3a performing image recording on the sheet S. A toner dispenser device U3b as an example of a supply device of developer is disposed above the image recording portion U3a.

In addition, the printer body U3 has a controller C as an example of a control portion. A client personal computer PC as an example of a transmitting device of image information is electrically connected to the controller C. The image information and the like transmitted from the client personal computer PC are input into the controller C. The controller C controls a laser drive circuit D, a power supply circuit E as an example of a drive circuit for an exposure device, and the like.

The laser drive circuit D outputs signals corresponding to the image information of Y: yellow, M: magenta, C: cyan, and K: black to exposure machines ROSy, ROSm, ROSc, and ROSk of each of the colors Y, M, C, and K at a time that is set in advance based on input information from the scanner portion U1 and the client personal computer PC.

A pull-out member U3c of an image forming unit is supported below the exposure machines ROSy, ROSm, ROSc, and ROSk of each of the colors Y, M, C, and K. The pull-out member U3c of the image forming unit is movably supported between a position in which the pull-out member U3c is pulled out to the front of the printer body U3 and a position in which the pull-out member U3c is mounted on an inside of the printer body U3 by a pair of right and left guide members R1 and R1.

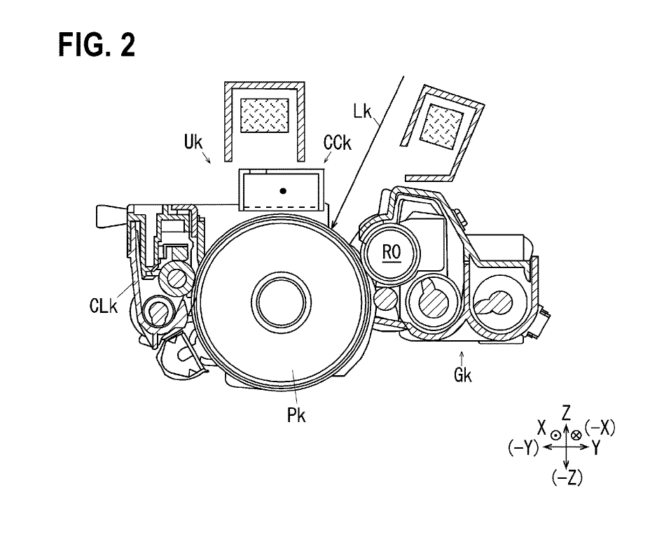

FIG. 2 is an explanatory view of a visible image forming member having an image holding member unit and a developing device of Example 1 of the invention.

In FIGS. 1 and 2, photoconductors Py, Pm, Pc, and Pk as examples of an image holding member are disposed below each of the exposure machines ROSy, ROSm, ROSc, and ROSk. In Example 1, the photoconductor Pk which is frequently used and a surface of which is often worn is configured to have a diameter greater than those of the photoconductors Py, Pm, and Pc of the other colors Y, M and C. Therefore, the photoconductor Pk of black K corresponds to a high speed rotation. In addition, the photoconductor Pk of black K has along service life.

A charger CCk as an example of a charging device is disposed above the photoconductor Pk of black K. A developing device Gk is disposed on a downstream side of the charger CCk in a rotating direction of the photoconductor Pk. The developing device Gk has a developing roll R0 as an example of a developer holding member. A primary transfer roll T1k as an example of a primary transfer device is disposed on the downstream side of the developing device Gk in the rotating direction of the photoconductor Pk. A cleaner CLk as an example of a cleaning device for the photoconductor is disposed on the downstream side of the primary transfer roll T1k in the rotating direction of the photoconductor Pk.

A photoconductor unit Uk of black K as an example of the image holding member unit of Example 1 includes the photoconductor Pk, the charger CCk, and the cleaner CLk. Therefore, the photoconductor Pk, the charger CCk, and the cleaner CLk are configured integrally detachably with respect to the printer body U3. Similar to the photoconductor unit Uk of black K, photoconductor units Uy, Um, and Uc of the other colors Y, M, and C also include photoconductors Py, Pm, and Pc, chargers CCy, CCm, and CCc, and cleaners CLy, CLm, and CLc.

Visible image forming members Uy+Gy; Um+Gm, Uc+Gc, and Uk+Gk of Example 1 include the photoconductor units Uy, Um, Uc, and Uk, and developing devices Gy, Gm, G, and Gk The photoconductor units Uy, Um, Uc, and Uk, and the developing devices Gy, Gm, Gc, and Gk are respectively detachably supported on the pull-out member U3c of the image forming unit.

A pull-out member U3d of the intermediate transfer body is supported below the pull-out member U3c of the image forming unit The pull-out member U3d of the intermediate transfer body is movably supported between a position in which the pull-out member U3d is pulled out to the front of the printer body U3 and a position in which the pull-out member U3d is mounted on the inside of the printer body U3. A belt module BM as an example of an intermediate transfer device is supported on the pull-out member U3d of the intermediate transfer body. The belt module BM is vertically movably supported between a position in which the belt module BM is in contact with lower surfaces of the photoconductors Py, Pm, Pc, and Pk, and a position in which the belt module BM is separated from the lower surfaces of the photoconductors Py, Pm, Pc, and Pk downward by the pull-out member U3d of the intermediate transfer body.

The belt module BM has an intermediate transfer belt B, belt support rolls Rd, Rt, Rw, Rf as examples of a support member that supports an intermediate transfer body, and T2a, and the primary transfer rolls T1y, T1m, T1c, and T1k. The belt support rolls Rd, Rt, Rw, Rf, and T2a has the belt driving roll Rd as an example of a driving member that drives the intermediate transfer body, the tension roll Rt as an example of a tension applying member, the walking roll Rw as an example of a belt meandering prevention member, plural idler rolls Rf as an example of a driven member, and the backup roll T2a as an example of a facing member for secondary transfer. The intermediate transfer belt B is rotatably supported by the belt support rolls Rd, Rt, Rw, Rf, and T2a in an arrow Ya direction.

A belt cleaner CLB as an example of a cleaning device is disposed in the vicinity of the belt driving roll Rd.

A secondary transfer unit Ut is disposed below the backup roll T2a. The secondary transfer unit Ut has a secondary transfer roll T2b as an example of a secondary transfer member. A secondary transfer region Q4 as an example of a recording region of the image is formed by a region in which the secondary transfer roll T2b is in contact with the intermediate transfer belt B. In addition, a contact roll T2c as an example of a contact member for a voltage application is incontact with the backup roll T2a. A secondary transfer voltage of the same charging polarity as a charging polarity of toner at time which is set in advance is applied from the power supply circuit E controlled by the controller C to the contact roll T2c.

The secondary transfer device T2 of Example 1 includes the backup roll T2a, the secondary transfer roll T2b, and the contact roll T2c. A transfer device T1+B+T2 of Example 1, which transfers the images on the surfaces of the photoconductors Py to Pk to the sheet S, include the primary transfer rolls T1y, T1m, T1c, and T1k, the intermediate transfer belt B, and the secondary transfer device T2.

An entrance path SH2 as an example of the transporting path is formed below the belt module BM. The entrance path SH2 extends from the supply path SH1 of the sheet feeding device U2 to the secondary transfer region Q4. Plural transporting rolls Ra as an example of the transporting member of the medium are disposed in the entrance path SH2. In addition, a registration roll Rr as an example an adjusting member for adjusting transporting timing of the sheet S to the secondary transfer device T2 is disposed on an upstream side of the secondary transfer region Q4 in the transporting direction of the sheet S in the entrance path SH1. A guide member SGr of the medium is disposed on a downstream side of the registration roller Rr in the transporting direction of the sheet S. Moreover, the guide member SGr of the medium is fixed to the printer body U3 together with the registration roller Rr. A guide member SG1 of the medium before transfer is disposed between the guide member SGr of the medium and the secondary transfer region Q4.

A guide member SG2 of the medium alter transfer is disposed on the long side of the secondary transfer region Q4 in the transporting direction of the sheet S. A transport belt BH as an example of the transporting member of the medium is disposed on the downstream side of the guide member SG2 of the medium after the transfer in the transporting direction of the sheet S. A fixing device F is disposed on the downstream side of the transport belt BH in the transporting direction of the sheet S. The fixing device F has a heating roll Fh as an example of a fixing member for heating and a pressure roll Fp as an example of a fixing member for pressing. A fixing region Q5 is farmed by a region in which the heating roll Fh is in contact with the pressure roll Fp.

The image recording portion U3a of Example 1 includes the forming member Uy+Gy to Uk+Gk of the visible image, the transfer device T1+B+T2, and the fixing device P.

An exit path SH3 as an example of the transporting path is formed on the downstream side of the fixing device F in the transporting direction of the sheet S. The exit path SH3 extends toward upper right from a downstream side end of the entrance path SH2 in the transporting direction of the sheet S. The transporting roll Ra is disposed in the exit path SH3. An exit roll Rh as an example of an exit member of the medium is disposed in the downstream side end of the exit path SH3 in the transporting direction of the sheet S.

An upstream side end of a reverse path SH4 as an example of the transporting path in the transporting direction of the sheet S is connected to a connection portion between the entrance path SH2 and the exit path SH3. The reverse path SH4 extends downward. A reverse roll Rb, which is able to be forwardly and reversely rotatable as an example of a sheet reversing member of the medium, is disposed in the reverse path SH4. An upstream side end of an exiting reverse path SH5 as art example of the transporting path in the transporting direction of the sheet S is connected in the middle of the reverse path SH4. A downstream side end in the exiting reverse path SH5 in the transporting direction of the sheet S is connected to the exit path SH3. An upstream side end of a circulating path SH6 as an example of the transporting path in the transporting direction of the sheet S is connected to the downstream side of a connection portion of the exiting reverse path SH5 in the middle of the reverse path SH4. The circulating path SH6 connects the reverse path SH4 and the supply path SH1 of the sheet feeding device U2. The transporting roll Ra is disposed in the circulating path SH6.

A switching gate GT1 as an example of a switching member of a transport destination is disposed in a connection portion between the entrance path SH2 and the exit path SH3.

A mylar gate GT2 as an example of a regulating member in the transporting direction is disposed in a connection portion between the reverse path SH4 and the exiting reverse path SH5.

A mylar gate GT3 as an example of a regulating member in the transporting direction is disposed, in a connection portion between the reverse path SH4 and the circulating path SH6.

A body transporting path SH of Example 1 includes elements indicated by the symbols SH1 to SH6 described above.

### Operation of Image Recording Portion U3a of Example 1

In the printer U, if the image information is input from the client personal computer PC or the scanner portion U1 into the controller C, job which is the image forming operation is started. If the job is started, the photoconductors Py to Pk, the intermediate transfer belt B, and the like are rotated.

A voltage set in advance by the power supply circuit E is applied to the chargers CCy to CCk and the surfaces of the photoconductors Py to Pk are charged. The exposure machines ROSy to ROSk output laser beams Ly, Lm, Lc, and Lk as an example of light for writing a latent image in accordance with a signal from the laser drive circuit D. The electrostatic latent images to which the laser beams Ly to Lk are applied are written on the surfaces of the photoconductors Py to Pk.

The developing rolls R0 the developing devices Gy to Gk develop the electrostatic latent images of the surfaces of the photoconductors Py to Pk to the visible images.

The toner dispenser device U3b performs supply of developer consumed in the developing devices Gy to Gk.

A primary transfer voltage of an opposite polarity to a charging polarity of developer is applied to the primary transfer rolls T1y to T1k by the power supply circuit E and the visible image of the surfaces of the photoconductors Py to Pk is transferred to the surface of the intermediate transfer belt B.

The cleaners CLy to CLk remove and clean developer remaining on the surfaces of the photoconductors Py to Pk after the primary transfer.

When the intermediate transfer belt B passes through primary transfer regions Q3y to Q3k facing the photoconductors Py to Pk, images are transferred and laminated in order of Y, M, C, and K, and passes through the secondary transfer region Q4 facing the secondary transfer device T2. Moreover, in a case of a single color image, the single color image is transferred and passes through the secondary transfer region Q4.

The sheets S are housed in the sheet feeding tray trays TR1 to TR4. The sheets S of the sheet feeding tray trays TR1 to TR4 are transported to the supply path SH1 of the sheet feeding device U2 by the transporting roll Ra and enters the entrance path SH2 of the printer body U3.

The sheet S entered the entrance path SH2 is transported to the registration roller Rr.

The registration roller Rr delivers the sheet S to the secondary transfer region Q4 in accordance with a timing when the image of the surface of the intermediate transfer belt B is delivered to the secondary transfer region Q4.

In the secondary transfer device T2, a secondary transfer voltage is applied to the backup roll T2a from the power supply circuit E via the contact roll T2c. The polarity of the secondary transfer voltage is set to the same polarity as a charging polarity of developer which is set in advance. Therefore, the image of the intermediate transfer belt B is transferred to the sheet S passing through the secondary transfer region Q4.

The belt cleaner CLB removes and cleans developer remaining on the surface of the intermediate transfer belt B after the image is transferred in the secondary transfer region Q4.

The surface of the transport belt BH holds the sheet S to which the image is transferred by the secondary transfer device T2 and the transport belt BH transports the sheet S to the fixing device F.

The fixing device F heats the sheet S passing through the fixing region Q5 while pressing the sheet S. Therefore, an unfixed image of the surface of the sheet S is fixed to the sheet S. The sheet S to which the image is fixed is transported to the downstream side end of the entrance path SH2 in the transporting direction of the sheet S.

The switching gate GT1 of the downstream side end of the entrance path SH2 in the transporting direction of the sheet S selectively switches the transport destination of the sheet S to one of the exit path SH3 and the reverse path SH4.

In a case where the front surface and the rear surface of the sheet S are reversed and discharged, or in a case where duplex printing is performed, the transport destination of the sheet S where an image is recorded on a first surface is switched to the reverse path SH4. Therefore, the sheet S is guided to the reverse path SH4. In the reverse path SH4, the sheet S is transported by the reverse roll fib and passes through the mylar gate GT2.

In a case where the front surface and the rear surface of the sheet S are reversed and discharged, the reverse roll Rb is reversely rotated when an upstream side end of the sheet S in the transporting direction of the sheet S passes through the mylar gate GT2. Therefore, the sheet S is transported in a reverse direction, is a so-called switch back. In addition, in a case where duplex printing is performed, the reverse roll Rb switches back the sheet S by being reversely rotated when the upstream side end of the sheet S in the transporting direction of the sheet S passes through the mylar gate GT2 and the mylar gate GT3.

The mylar gate GT2 causes the sheet S transported to the reverse path SH4 to pass through once as it is. Then, the mylar gate GT2 regulates the transporting direction of the sheet S which is switched hack and guides the sheet S to the exiting reverse path SH5. Therefore, die sheet S is guided from the exiting reverse path SH5 to the exit path SH3.

The mylar gate GT3 causes the sheet S transported to the reverse path SH4 to pass through once as it is. Then, the mylar gate GT3 regulates the transporting direction of the sheet S which is switched hack and guides the sheet S to the circulating path SH6.

The sheet S transported to the circulating path SH6 is transported to the supply path SH1 of the sheet feeding device U2. Therefore, the sheet S which is switched back is delivered again from the supply path SH1 to the registration roller Rr of the entrance path SH2 in a state where the front surface and the rear surface are reversed. Therefore, an image is also recorded on a second surface of the sheet S.

In a case where the sheet S on which the image is recorded is discharged from the printer body U3, the transport destination of the sheet S is switched to the exit path SH3. Therefore, the sheet S on which the image is recorded is guided to the exit path SH3. In the exit path SH3, the sheet S is transported by the transporting roll Ra and is discharged from the printer body U3 by the exit roll Rh.

### Description o f Configuration of Finisher U4 of Example 1

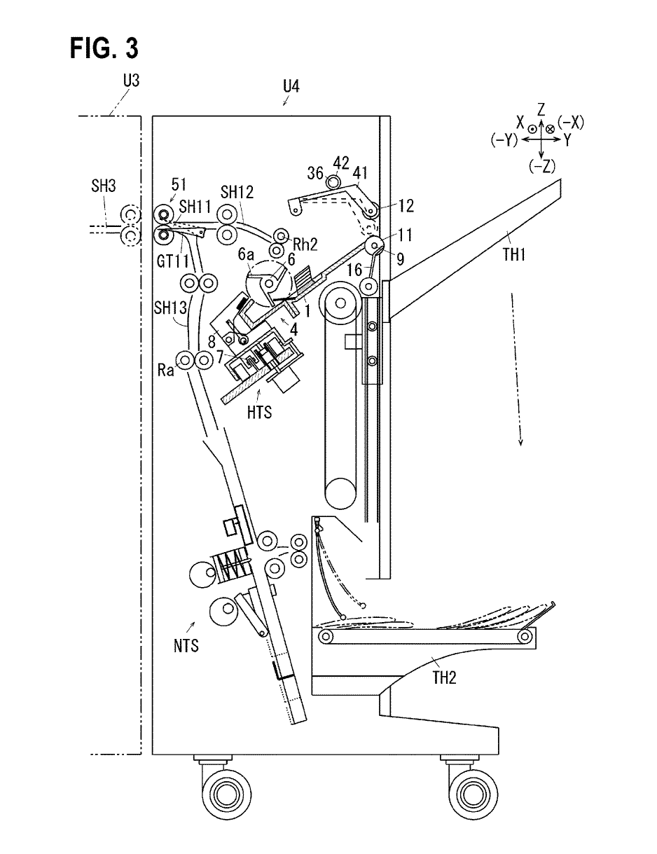

FIG. 3 is an explanatory view of the post-processing device of Example 1 of the invention.

In FIGS. 1 and 3, the finisher U4 as an example of the post-processing device is disposed on the right side of the printer body U3. The finisher U4 has an entrance path SH11 as an example of the transporting path. The entrance path SH11 extends from the downstream side end of the exit path SH3 of the printer body U3 in the transporting direction of the sheet S to an inside of the finisher U4. An side stitching transporting path SH12 extending on the right side as an example of the transporting path is connected to the downstream side end of the entrance path SH11 in the transporting direction of the sheet S. In addition, a saddle stitching transporting path SH13 extending downward as an example of the transporting path is connected to the downstream side end of the entrance path SH11 in the transporting direction of the sheet S.

A gate GT11 as an example of the switching member of the transport destination is disposed in a branch position between the side stitching transporting path SH12 and the saddle stitching transporting path SH13.

An side stitching device HTS is disposed on the downstream side end of the side stitching transporting path SH12 in the transporting direction of the sheet S. A stacker tray TH1 as an example of a side stitching exit portion is supported on the downstream side of the side stitching device HTS in the transporting direction of the sheet S. The stacker tray TH1 is vertically movably supported.

A saddle stitching device NTS is disposed on the downstream side of the saddle stitching transporting path SH13 in the transporting direction of the sheet S. Moreover, the saddle stitching device NTS is known in the related art and, for example, may employ configurations described in JP-A-2003-089462, JP-A-2003-089463, JP-A-2006-69746, JP-A-2006-69749, and the like. Therefore, the detailed description of the saddle stitching device NTS will be omitted. A saddle stacker tray TH2 as an example of a saddle exit portion is supported on the downstream side of the saddle stitching device NTS in the transporting direction of the sheet S.

### Operation of Finisher U4 of Example 1

In the finisher U4 described above, the sheet S enters the entrance path SH11 from the printer body U3. The sheet S entered the entrance path SH11 passes through the position of the gate GT11.

The gate GT11 selectively switches the transport destination of the sheet S to one of the side stitching transporting path SH12 and the saddle stitching transporting path SH13 in accordance with setting of the post-processing.

The sheet S transported to the side stitching transporting path SH12 is transported to the side stitching device HTS.

The side stitching device HTS aligns the ends of the sheets S by making plural sheets S in a bundle (matching process), or stitches the ends of the sheets S of the bundle (side stitching process). The sheets S which are processed by the side stitching device HTS are discharged to the stacker tray TH1.

The stacker tray TH1 is lowered in accordance with a loading amount of the sheets S if the sheets S are loaded.

The sheet S transported to the saddle stitching transporting path SH13 is transported to the saddle stitching device NTS.

The saddle stitching device NTS stitches center portions in the transporting direction of the sheet S by making the plural sheets S in a bundle. Then, the saddle stitching device NTS two-folds the bundle of the stitched sheets S in the center portion and discharges the bundle to the saddle stacker tray TH2.

### Detailed Description of Side Stitching Transporting Path of Example 1

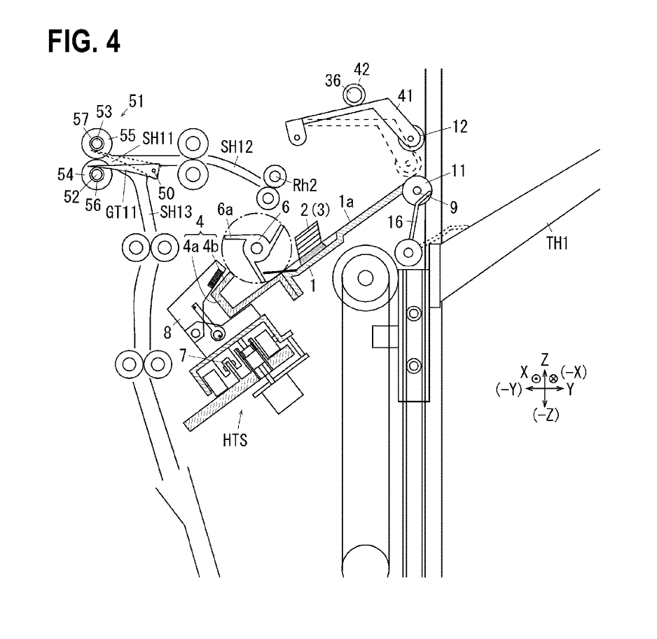

FIG. 4 is an explanatory view of the side stitching device of Example 1 of the invention and is an explanatory view illustrating a movement of a clamp roller.

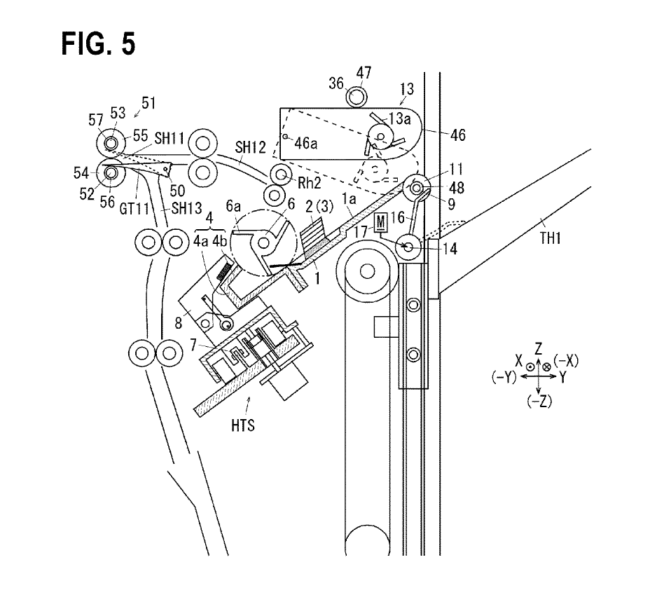

FIG. 5 is an explanatory view of the side stitching device of Example 1 of the invention and an explanatory view illustrating a movement of a sub-paddle.

In FIGS. 4 and 5, an exit roll Rh2 as an example of the exit member and as an example of an entrance member is disposed in the downstream side end of the side stitching transporting path SH12 in the transporting direction of the sheet S.

### Detailed Description of Side Stitching Device of Example 1

In FIGS. 4 and 5, the side stitching device HTS is disposed on the downstream side of the exit roll Rh2 in the transporting direction of the sheet S.

The side stitching device HTS has a compiling tray 1 as an example of a loading portion. A loading surface 1a in which the plural sheets S are loaded is formed in the compiling tray 1. The loading surface 1a is gently inclined with respect to horizon so that the right side is upward.

Tampers 2 and 3 as an example of an alignment member of ends of the medium in a width direction are disposed on the compiling tray 1. A pair of the tampers 2 and 3 are disposed forth and rear. Each of the tampers 2 and 3 is movably supported in the forward and rearward direction. Therefore, the tampers 2 and 3 are configured to be approached and separated from each other.

An end wall 4 as an example of an alignment portion of the ends of the medium in the transporting direction is supported on left below the compiling tray L The end wall 4 has a positioning wall 4a that rises upward with respect to the loading surface 1a of the compiling tray 1 and a guide wall 4b that extends upper right from, an upper end of the positioning wall 4a. A main paddle 6 as an example of a first lead-in member is supported above the end wall 4. The main paddle 6 is rotatably supported. Flexible sheet contact portions 6a extending to the outside in a radial direction are provided in the main paddle 6. The sheet contact portion 6a is configured to be in contact with the sheet S on the compiling tray 1. Driving is transmitted from a driving source (not illustrated) to the main paddle 6.

A stapler guide 7 as an example of a guide member of a stitching member is supported left below the end wall 4. The stapler guide 7 extends the forward and rearward direction along the end wall 4.

A stapler 8 as an example of the stitching member is supported on the stapler guide 7. The stapler 8 is movably configured along the stapler guide 7. Therefore, the stapler 8 is movably supported along the end wall 4 in the forward and rearward direction.

An exit shall 9 extending the forward and rearward direction is provided right above the compiling tray 1. The exit shaft 9 is rotatably supported. An eject roller 11 as an example of a second exit portion is supported on the exit shall 9. Here, the exit shaft 9 is configured such that forward and rearward driving from a driving source (not illustrated) is able to be transmitted to the exit shaft 9. Therefore, the eject roller 11 is configured to be forward and rearward rotatable.

In FIG. 4, a clamp roller 12 as an example of a moving member, as an example of an exit member, and as an example of a clamping member of the medium is disposed above the eject roller 11. The clamp roller 12 is configured to be movable between a lowered position indicated by a broken line of FIG. 4 as an example of a first position and a lifted position indicated by a solid line of FIG. 4 as an example of a second position. In the lifted position, the clamp roller 12 is separated from the eject roller 11. In addition, in the lowered position, the clamp roller 12 approaches the eject roller 11 and is in contact with the sheet S.

In FIG. 5, a sub-paddle 13 as an example of a moving member and as an example of a second lead-in member is disposed above the compiling tray 1 in a position shifted from the clamp roller 12 in the forward and rearward direction. The sub-paddle 13 is rotatably supported. Flexible sheet contact portions 13a extending to the outside in the radial direction is provided in the sub-paddle 13. Driving is transmitted from a driving source (not illustrated) to the sub-paddle 13 via a pulley and a belt (not illustrated) as an example of a transmitting member of the driving.

The sub-paddle 13 is movably configured between a lowered position indicated by a broken line of FIG. 5 as an example of a first position and a lifted position indicated by a solid line of FIG. 5 as an example of a second position. In the lifted position, the sub-paddle 13 is separated from the compiling tray 1. In addition, in the lowered position, the sub-paddle 13 is in contact with the sheet S loaded in the compiling tray 1.

Moreover, in the side stitching device HTS, the tampers 2 and 3, the main paddle 6, the stapler 8, and the like may apply, for example, configurations described in JP-A-2003-89463, JP-A-2006-69746, JP-A-2009-240970, and the like. Therefore, the further detailed description of the configurations will be omitted.

In FIG. 5, a rotation shaft 14 extending in the forward and rearward direction is disposed below the eject roller 11. A clamp member 16 as an example of a pressing member is supported on the rotation shaft 14. Forward and rearward driving from a stepping motor 17 as an example of a driving source is transmitted to the rotation shaft 14 of the clamp member 16. Therefore, the clamp member 16 is movably configured between a retracted position indicated by the solid line of FIG. 5 and an operation position as an example of a suppressed position indicated by the broken line of FIG. 5. In the retracted position, the clamp member 16 is retracted from a range through which the sheet S passes in a case where the sheet S discharged from the compiling tray 1 is loaded in the stacker tray TH1. That is, the clamp member 16 is retracted to a position that does not interfere with the discharging of the sheet S. In addition, in the operation position, the clamp member 16 approaches the upper surface of the sheet S loaded in the stacker tray TH1 aid presses the sheet S.

In FIGS. 4 and 5, the stacker tray TH1 extending to upper right as an example of a medium, exit portion is disposed on the downstream side of the compiling tray 1 in the transporting direction of the sheet. Moreover, mechanisms for lifting the stacker tray TH1 and the-slacker tray TH1 may apply, for example, configurations described in JP-A-2003-89463, JP-A-2006-69746, and the like.

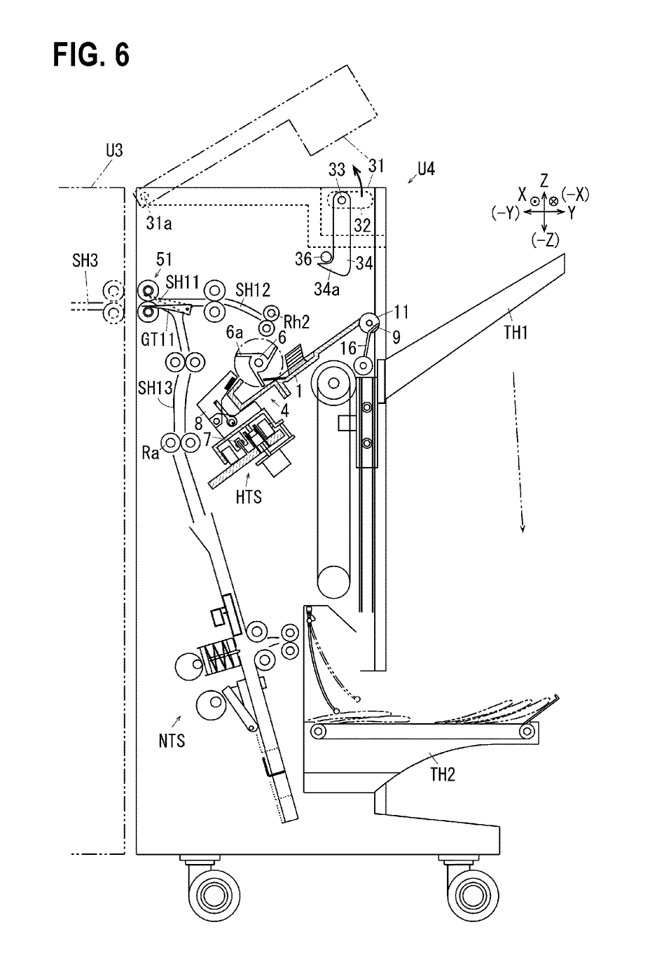

FIG. 6 is an explanatory view of an opening and closing mechanism of an exterior member in the post-processing device of Example 1.

In FIG. 6, in the finisher U4 of Example 1, an opening and closing cover 31 is supported on an upper portion to be rotatable around a rotation center 31a. The opening and closing cover 31 is movably supported between a closed position indicated by a solid line of FIG. 6 and an opened position indicated by a two-dotted, chain line of FIG. 6. In the opened position, the upper portions of the clamp roller 12 and the sub-paddle 13 are opened and maintenance work such as removing the paper jammed in the compiling tray 1 or replacement of failed or degraded components. A latch handle 32 as an example of a grip portion is disposed, in a front portion in the opening and closing cover 31. The latch handle 32 is rotatably supported around a latch shaft 33 as an example of a second stop member and as an example of a rotation shaft. The latch shaft 33 extends in the forward and rearward direction. A latch plate 34 as an example of a hook member is supported on a front end portion of the latch shaft 33. A hooked claw portion 34a is formed in a lower end portion of the latch plate 34. The claw portion 34a is formed to be hooked in a stopper shaft 36 as an example of a stop portion. The stopper shaft 36 is formed, in a shaft shape extending in the forward and rearward direction. Therefore, in a case where the latch handle 32 is rotated, the claw portion 34a is removed from the stopper shaft 36 and the opening and closing cover 31 is in a state of being capable of opening and closing. Moreover, the claw portion 34a holds the opening and closing cover 31 in the closed position in a state of being hooked in the stopper shall 36.

In FIG. 4, in Example 1, in a case where the clamp roller 12 is moved to the lifted position, an arm portion 41 as an example of a support body that supports the clamp roller 12 conies into contact with the stopper shaft 36 as an example of a second stop member and stops. In Example 1, a first cushion 42 as an example of a second shock absorber is supported on an outer periphery of the stopper shaft 36. Moreover, the first cushion 42 is configured by attaching a resin film as an example of a low friction material to a surface made of a rubber material as an example of an elastic material. Moreover, as the resin film, for example, a thin film made of for example, polyethylene terephthalate (PET) may be used. The first cushion 42 of Example 1 is welded to the stopper shaft 36. In addition, the first cushion 42 of Example 1 is provided at an internal corresponding to the position of plural clamp rollers 12 which are spaced apart in an axial direction of the stopper shaft 36.

Moreover, in a case where the clamp roller 12 is moved to the lowered position, the clamp roller 12 comes into contact with the eject roller 11 as an example of a first shock absorber supported on the exit shaft 9 as an example of a first stop member and stops.

In FIG. 5, the sub-paddle 13 of Example 1 has a support frame 46 as an example of a support body. The support frame 46 is rotatably supported around a rotation shaft 46a. In a case where the sub-paddle 13 is moved to the lifted position, the support frame 46 as an example of a support body that supports the sub-paddle 13 comes into contact with the stopper shaft 36 as an example of a second stop member and stops. Moreover, a second cushion 47 as an example of a second shock absorber is supported on the stopper shaft 36 to correspond, to a position that is in contact with the support frame 46. Similar to the first cushion 42, the second cushion 47 of Example 1 is used by attaching a film to a surface made of a rubber material.

In addition, in a case where the sub-paddle 13 is moved to the lowered position, both front and rear end portions of the support frame 46 come into contact with the exit shaft 9 as an example of a first stop member and stop. That is, the support frame 46 is formed in a substantially gate shape when the both front and rear end portions (stopped portions) of the support frame 46 are viewed on the stacker tray TH1 side so as to be in contact with the exit shaft 9 on an outside from both, ends of the medium housed in the compiling tray 1 in the width direction. Moreover, in Example 1, a third cushion 48 as an example of a first shock absorber is supported on the exit shaft 9 to correspond to a position that is in contact with the support frame 46. Moreover, the third cushion 48 is configured similar to the first cushion 42 and the second cushion 47.

In FIGS. 3 to 5, in Example 1, a transporting roller 51 as an example of a transporting member is disposed on the upstream side of the gate GT11 in the transporting direction of the sheet S. The transporting roller 51 has a pair of driving shaft 52 and driven shaft 53 facing each other. In Example 1, each of the rotation shafts 52 and 53 is configured in a rod shape extending in the forward and rearward direction.

Plural driving rollers 54 as an example of a driving member are disposed to be spaced apart in the axial direction in the driving shall 52 as an example of a first stop member. Plural driven rollers 55 as an example of a driven member are disposed to correspond to the driving rollers 54 in the driven shaft 53 as an example of a second stop member.

The gale GT11 as an example of a switching member and as an example of a moving member is rotatably supported around a rotation shaft 50. The gate GT11 of Example 1 is movably configured between a side stitching guide position indicated by a solid line of FIG. 3 as an example of the first position and a saddle stitching guide position indicated by a broken line of FIG. 3 as an example of the second position. Therefore, in a case where the gate GT11 is moved to the side stitching guide position, the sheet S is guided to the side stitching transporting path SB12 as an example of a first branch path. On the other hand, in a case where the gate GT11 is moved to the saddle stitching guide position, the sheet S is guided to the saddle stitching transporting path SH13 as an example of a second branch path.

An upstream side end portion of the gate GT11 of Example 1 in the transporting direction of the sheet S is formed in a comb shape and is configured to enter between the driving roller 54 and the driven roller 55 in the axial direction. In a case where the gate GT11 is moved to the side stitching guide position, the upstream side end portion comes into contact with the driving shaft 52 and stopped. In addition, in a case where the gate GT11 is moved to the saddle stitching guide position, the upstream, side end portion comes into contact with the driven shaft 53 and stopped.

In FIGS. 3 to 5, a fourth cushion 56 as an example of a first shock absorber is supported on the driving shaft 52. In addition, a fifth cushion 57 as an example of a second shock absorber is supported on the driven shaft 53. The fourth cushion 56 and the fifth cushion 57 are configured similar to the first to third cushions 42, 47, and 48. In addition, the fourth cushion 56 and the fifth cushion 57 are disposed between the rollers 54 and 55 to correspond to a position that is in contact with the gate GT11.

### Detection of Operation of Side Stitching Device HTS of Example 1

In the finisher U4 of Example 1 including the configuration described above, in a case where setting of the side stitching and setting of discharging the bundle of the sheets S without stitching the bundle of the sheets S, a so-called setting of set discharging are performed. The gate GT11 is moved to the side stitching guide position. Moreover, in a case where setting of the saddle stitching is performed, the gate GT11 is moved to the saddle stitching guide position. In a case where the gate GT11 is moved to the side stitching guide position, the sheet S entered the finisher U4 is discharged to the compiling tray 1. If the sheet S discharged to the compiling tray 1 is discharged, the sub-paddle 13 is moved to the lowered position. Then, the sheet is led toward the end wall 4 by the rotation of each of paddles 6 and 13. Then, the sheet S abuts against the end wall 4 and the transporting direction of the sheet S is aligned. If the sheet S is led in the position of the main paddle 6, the sub-paddle 13 is moved to the lifted position.

Then, if the sheets S are loaded in the compiling tray 1, the tampers 2 and 3 are operated and the width direction of the sheet S is aligned.

Whenever the sheet S enters the compiling tray 1, lifting and lowering of the sub-paddle 13, and the operation the tampers 2 and 3 are performed.

In a case of setting in which the sheets S are aligned and discharged, if one set of the sheets S is loaded in the compiling tray 1, the clamp roller 12 is moved to the lowered position and the sheets S are sandwiched between the eject roller 11 and the clamp roller 12. Then, the eject roller 11 is operated and thereby the sheets S are discharged to the stacker tray TH1.

In a case where setting of the side stitching is performed, if one set of the sheets S is loaded in the compiling tray 1, the stapler 8 is operated and thereby the set stitching position is stitched by needles. Then, similar to a case of the set discharging, the sheets S are sandwiched between the clamp roller 12 and the eject roller 11, and the stitched bundle of the sheets S is discharged to the stacker tray TH1.

Moreover, whenever the bundle of the sheets S is disposed to the stacker tray TH1, the clamp member 16 is in contact with the uppermost surface of the bundle of the sheets S and the discharged bundle of the sheets S is pressed by the next discharged bundle of the sheets S so as to prevent disorder thereof.

In the finisher U4 of Example 1, when the sub-paddle 13 is moved to the lifted position or the lowered position, the support frame 46 is in contact with the cushions 47 and 48. Therefore, in a case where the cushions 47 and 48 are not provided, the support frame 46 collides with the stopper shaft 36 or the exit shaft 9. Therefore, when colliding with the stopper shaft 36 or the exit shall 9, vibration or noise occurs. In addition, if the support frame 46 collides with the stopper shaft 36, the opening and closing cover 31 is vibrated via the stopper shaft 36. The opening and closing cover 31 has a wide entire surface area and there is a problem that the opening and closing cover 31 is likely to be sounded if the vibration is transmitted and is likely to be largely vibrated.

In the configuration described in JP-A-2006-208525 (paragraphs [0021] to [0023] and FIG. 2), the shock absorber is provided in an external cover (52) rather than a stopper portion that is in contact with a developing unit. The developing unit is stopped before the developing unit is in contact with the stopper portion or, in contrast, the developing unit is in contact with the stopper portion before the impact is absorbed by accuracy of a size and a position of the shock absorber, and an individual difference in an impact absorbing capacity. If the developing unit is stopped before the developing unit is in contact with the stopper portion, a positional accuracy of the movement of the developing unit is not ensured. In addition, if the developing unit is in contact with the stopper portion before the impact is absorbed, the developing unit collides with the stopper portion, and thereby there is a problem that vibration sound cannot be suppressed and propagation of the vibration from the stopper portion to the cover via the image forming apparatus main body having a large surface area remains.

In contrast, in Example 1the cushions 47 and 48 are disposed in the stopper shaft 36 and the exit shaft 9 against which the support frame 46 abuts. Therefore, the position, of the support frame 46 is accurately aligned by the stopper shaft 36 and the exit shaft 9. In addition, the support frame 46 is in contact with the cushions 47 and 48, and the impact to the stopper shaft 36 and the exit shaft 9 is absorbed. Therefore, in the finisher U4 of Example 1, a positional accuracy of the lifted position and the lowered position is improved and occurrence of the vibration and noise is suppressed compared to the technique described in JP-A-2006-208525 (paragraphs [0021] to [0023] and FIG. 2).

In addition, in the finisher 114 of Example 1, when the clamp roller 12 is moved to the lifted position, the first cushion 42 is supported on the stopper shaft 36 against which the arm portion 41 abuts. Therefore, occurrence of the vibration and noise is suppressed while the positional accuracy of the clamp roller 12 is improved.

Furthermore, in the finisher U4 of Example 1, when the gate GT11 is moved between the side stitching guide position and the saddle stitching guide position, the cushions 56 and 57 are supported on the rotation shafts 52 and 53 against which the gate GT11 abuts. Therefore, occurrence of the vibration and noise is suppressed while the positional accuracy of the gate GT11 is improved. Particularly, the positional accuracy of the gate GT11 is improved and thereby occurrence of paper jamming in the branch portion is reduced compared to a case where the gate GT11 does not abut against the rotation shafts 52 and 53.

In addition, in Example 1, each of the cushions 42, 47, 48, 56, and 57 has a configuration in winch the resin film of low friction is supported on the surface made of the rubber material. Therefore, wear is reduced when the exit shaft 9, the driving shaft 52, and the driven shaft 53 are rotated in a state of being in contact with the support frame 46 and the gate GT11 compared to a configuration in which a rubber material having no resin film is exposed. Moreover, the resin film is not necessary to be provided in the first cushion 42 and the second cushion 47 in the stopper shall 36 that is a non-rotating member. It is possible to be a common component by causing the first cushion 42 and the second cushion 47 to have the common configuration with the other cushions 48, 56, and 57.

### MODIFICATION EXAMPLES

Above, the exemplary example of the invention is described in detail, but exemplary embodiments of the invention are not limited to the example, and various modifications can be performed within the range of the gist of exemplary embodiments of the invention described in the claims. Modification example (H01) to (H05) of the exemplary embodiments of the invention are exemplified as follows.

(H01) In the exemplary example described above, the printer U is exemplified, as an example of the image forming apparatus, but the image forming apparatus is not limited to the printer U, and it is possible to apply to a configuration having the post-processing device such as a FAX, a copier, and a multifunction machine having plural functions.
(H02) In the exemplary example described above, as the main paddle 6, a configuration, in which the sheet contact portion 6a is inclined with respect to the shaft portion in the radial direction, is exemplified, but the main paddle 6 is not limited to the configuration. The sheet contact portion 6a may be configured to extend in the radial direction. Moreover, the sub-paddle 13 is also similar thereto.
(H03) In the exemplary example described above, a configuration, in which the cushions 42, 47, 48, 56, and 57 as an example of the shock absorber are disposed in each of the members 12, 13, and GT11 in the post-processing device, is exemplified, but the example is not limited to the configuration. For example, it is also possible to apply to a member (roller and unit) moving in the sheet feeding device 112 and the printer body U3 and a switching member of the transporting path.
(H04) In the exemplary example described above, a configuration, in which the cushions 47 and 48 that absorb the impact during movement of the sub-paddle 13 are provided in the stopper shaft 36 and the exit shaft is exemplified, but the cushions 47 and 48 are not limited to the configuration. For example, it is also possible to have a configuration in which the cushions 47 and 48 are provided in the support frame 46 of the sub-paddle 13 and are not provided in the stopper shaft 36 and the exit shaft 9, or a configuration in which the cushions 47 and 48 are disposed on both sides. In addition, for example, it is also possible to have a configuration in which a cushion is provided in the stopper shaft 36 and a cushion is not provided in the exit shaft 9, and a cushion is provided in the support fame 46 only on the exit shaft 9 side. Moreover, the clamp roller 12 and the gate GT11 are also similar thereto.

(H05) In the exemplary example described above, as the cushions 42, 47, 48, 56, and 57, it is preferable that a configuration, in which the resin film as an example of a low friction material is provided on the outer periphery of the rubber material, is provided, but the resin film may be omitted. Moreover, it is also possible to form a surface layer of a low friction material such as fluororesin in place of the resin film.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are sorted to the particular use contemplated. It is intended that the scope of the invention be defined by the following claims and their equivalents.

What is claimed is:

1. An image forming apparatus comprising:
a moving member that is movable between a first position and a second position different from the first position;
a first stop member that is disposed corresponding to the first position and comes into contact with the moving member to stop the moving member in the first position;
a second stop member that is disposed corresponding to the second position and comes into contact with the moving member to stop the moving member in the second position;
a first shock absorber that is disposed in at least one of the moving member and the first stop member, and absorbs impact at a time of contact; and
a second shock absorber that is disposed in at least one of the moving member and the second stop member, and absorbs impact at a time of contact.

2. The image forming apparatus according to claim 1, further comprising: a loading portion where a medium on which an image is recorded is loaded; and
the moving member that includes a transporting member transporting the medium loaded in the loading portion and is moved between the first position in which the transporting member is in contact with the medium and the second position in which the transporting member is separated from the medium.

3. The image forming apparatus according to claim 2, further comprising:
a transporting path that transports a medium and includes a first branch path and a second branch path;
a transporting member, wherein
the first branch path and the second branch path are disposed in a branch position,
the moving member includes a switching member that switches a transporting direction of the medium between the first position in which the medium is guided to the first branch path and the second position in which the medium is guided to the second branch path,
the transporting member is disposed on an upstream side of the branch position in the transporting direction of the medium, transports the medium, and includes a pair of rotation shafts that face each other,
the first stop member that includes one of the rotation shafts of the transporting member; and
the second stop member that includes the other of the rotation shafts of the transporting member.
